(19) United States
(12) Patent Application Publication
(10) Pub. No.: US 2026/0312809 A1
(43) Pub. Date: Oct. 8, 2026

(54) WHITE-LABEL NETWORK ENGINE FOR VERIFIED INFLUENCE, GOVERNANCE, AND GROUP OPTIMIZATION

(71) Applicant: George William Bickerstaff, III, Greenwich, CT (US)

(72) Inventor: George William Bickerstaff, III, Greenwich, CT (US)

(21) Appl. No.: 19/460,358

(22) Filed: Jan. 27, 2026

(51) Int. Cl. H04L 9/32

(52) U.S. Cl. CPC H04L 9/321

(57) ABSTRACT

A modular, computer-implemented white-label network engine validates influence records from multiple independent sources, applies normalization and percentile alignment, and generates composite influence scores with cryptographic provenance. A governance engine produces coalition formation, mission alignment, and scenario-based optimization outputs. An analytics dashboard delivers auditable, configurable, and compliance-ready decision support across organizational contexts.

### CROSS-REFERENCE TO RELATED APPLICATIONS

This application claims the benefit of U.S. Provisional Patent Application No. 63/847,049, filed Jul. 19, 2025, the entire contents of which are incorporated herein by reference.

### TECHNICAL FIELD

The present invention relates generally to computer-implemented governance and decision-support systems and, more particularly, to modular white-label platforms for validating, normalizing, scoring, and operationalizing influence and governance data across organizations, networks, and multi-stakeholder environments.

### BACKGROUND OF THE INVENTION

Organizations increasingly rely on influence, credibility, and governance indicators when making decisions involving leadership selection, advisory appointments, coalition formation, and institutional oversight. Existing systems attempting to quantify such indicators often depend on self-reported information, single-source datasets, or opaque methodologies that cannot be independently verified or audited.

Conventional analytics and governance platforms typically aggregate heterogeneous data without enforcing consensus validation, anomaly detection, provenance integrity, or normalization across peer groups, resulting in outputs that are not comparable, defensible, or suitable for regulated or fiduciary environments. These systems also lack mechanisms for modeling group-level dynamics, mission alignment, and resilience under changing conditions.

Additionally, most influence and governance platforms are delivered as fixed proprietary applications that cannot be branded, policy-controlled, or modularly configured by adopting organizations, limiting adoption by institutions requiring data sovereignty, auditability, and customization. There is therefore a need for a white-label network engine that provides verifiable, auditable, and configurable governance decision infrastructure.

### SUMMARY OF THE INVENTION

The present invention provides a modular, computer-implemented white-label network engine configured to ingest influence-related records from multiple independent sources, validate and normalize such records, generate composite influence and alignment scores, and produce governance and group optimization outputs suitable for high-stakes decision-making.

In one embodiment, authenticated records are corroborated using consensus validation and anomaly detection, secured through cryptographic provenance techniques, and protected by privacy controls prior to scoring. Validated data is transformed into percentile-aligned indices and composite scores that preserve comparability across peer groups and organizational contexts.

In further embodiments, the system produces governance outputs including coalition formation options, mission alignment evaluations, scenario testing results, and optimization mappings, all delivered through a configurable white-label analytics interface with full traceability and audit support.

### DEFINITIONS

ANALYTICS DASHBOARD—A configurable interface that presents influence scores, governance outputs, provenance views, comparison tools, and exportable reports for operational and compliance use.
ANOMALY DETECTION—A computational process for identifying inconsistent, improbable, or manipulated records or metrics prior to scoring.
COALITION FORMATION—A process for generating candidate groupings of individuals based on complementary influence attributes and governance constraints.
COMPOSITE INFLUENCE SCORE—A weighted aggregation of normalized influence indices reflecting governance priorities.
CONSENSUS VALIDATION—Corroboration of records using multiple independent authenticated sources.
GOVERNANCE ENGINE—A module that produces mission alignment evaluations, coalition options, and scenario-based governance outputs.
MISSION ALIGNMENT—A mapping of individuals or groups to predefined objectives, values, and constraints.
NORMALIZATION—Transformation of heterogeneous metrics into a standardized framework enabling percentile comparison.
PROVENANCE HASHING—Cryptographic generation of integrity proofs to ensure tamper resistance and auditability.
WHITE-LABEL DEPLOYMENT—A deployment model in which branding, policy rules, and module activation are configurable by an adopting organization.

### BRIEF DESCRIPTION OF THE DRAWINGS

FIG. 1 SYSTEM ARCHITECTURE OVERVIEW illustrates the modular architecture of the white-label network engine.

FIG. 2 VALIDATION WORKFLOW illustrates multi-source corroboration, anomaly detection, and provenance protection.

FIG. 3 INFLUENCE INTEGRATION WORKFLOW illustrates normalization and composite scoring.

FIG. 4 GOVERNANCE AND GROUP ENGINE illustrates coalition and mission alignment processing.

FIG. 5 ANALYTICS AND VISUALIZATION DASHBOARD illustrates output, comparison, and audit interfaces.

### DETAILED DESCRIPTION OF THE INVENTION

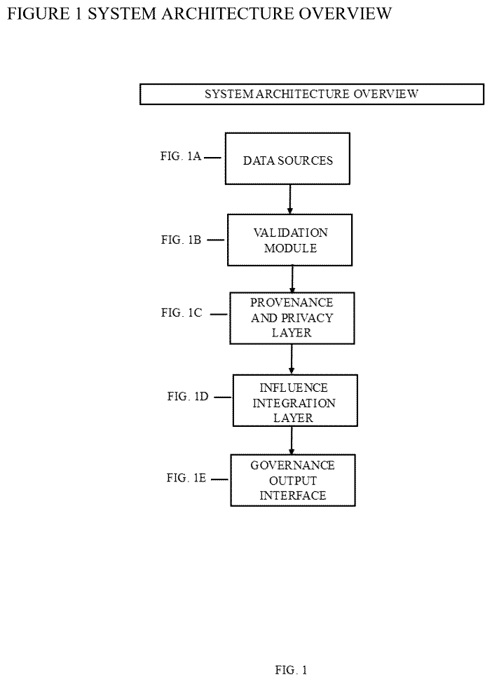

### FIG. 1 System Architecture Overview

FIG. 1 illustrates an end-to-end architecture in which authenticated influence records are ingested, validated, scored, and transformed into governance outputs. The architecture is modular, allowing selective activation of components while preserving traceability across the processing pipeline. The system supports distributed, hybrid, and localized deployments without altering functional integrity.

FIG. 1A DATA SOURCES illustrates independent authenticated repositories providing influence-related records from professional, academic, organizational, and network-based sources. Multiple sources reduce reliance on any single dataset and improve verification reliability. Source identity is preserved to support audit review.

FIG. 1B VALIDATION MODULE illustrates consensus validation and anomaly detection applied to incoming records prior to scoring. Records failing validation criteria are flagged or excluded from further processing. Validation outcomes are logged for traceability.

FIG. 1C PROVENANCE AND PRIVACY LAYER illustrates cryptographic hashing and privacy safeguards applied to validated records. Integrity proofs enable later verification without exposing sensitive raw data. Access is controlled according to configurable policies.

FIG. 1D INFLUENCE INTEGRATION LAYER illustrates transformation of validated records into normalized and percentile-aligned indices. Comparable influence measures are generated across peer groups and contexts. All transformations remain explainable and auditable.

FIG. 1E GOVERNANCE OUTPUT INTERFACE illustrates delivery of scored and optimized outputs to downstream governance engines and dashboards. Outputs retain provenance references to validation evidence. Secure system integration is supported.

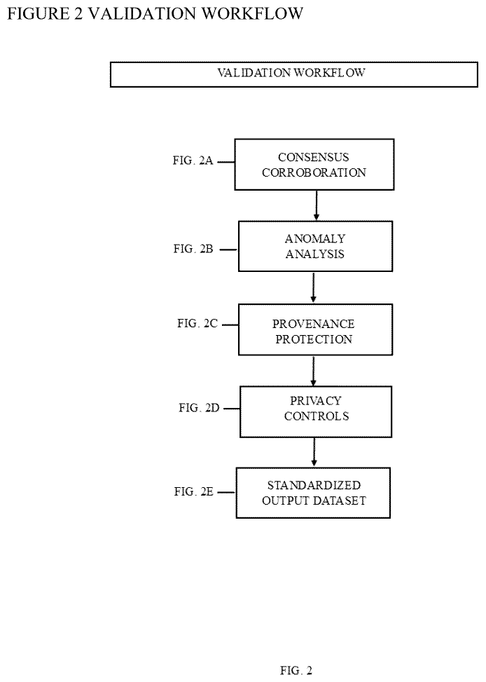

### FIG. 2 Validation Workflow

FIG. 2 illustrates a workflow in which authenticated records undergo corroboration, anomaly analysis, provenance protection, and privacy enforcement prior to scoring. Each stage ensures integrity before governance use. The workflow produces standardized, audit-ready datasets.

FIG. 2A CONSENSUS CORROBORATION illustrates cross-source confirmation of identity and attributes using independent repositories. At least two sources are required for corroboration. Supporting evidence is retained.

FIG. 2B ANOMALY ANALYSIS illustrates detection of improbable metrics or inconsistent attributes. Flagged records may be quarantined or reviewed. Logs are preserved.

FIG. 2C PROVENANCE PROTECTION illustrates cryptographic integrity measures applied to validated data. Hashes enable detection of tampering. Verification is independent.

FIG. 2D PRIVACY CONTROLS illustrates encryption and access restriction applied to sensitive attributes. Privacy rules are enforced by policy. Data exposure is minimized.

FIG. 2E STANDARDIZED OUTPUT DATASET illustrates validated and protected data prepared for scoring. Integrity metadata is retained. The dataset feeds downstream processing.

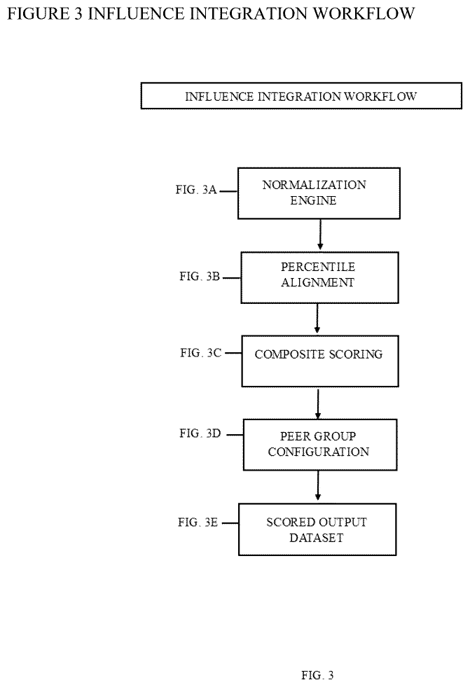

### FIG. 3 Influence Integration Workflow

FIG. 3 illustrates normalization, percentile alignment, and composite scoring of validated influence data. Influence signals are standardized for comparability. Scoring logic is transparent.

FIG. 3A NORMALIZATION ENGINE illustrates transformation of heterogeneous metrics into a standardized framework. Units and scales are aligned. Contextual metadata is preserved.

FIG. 3B PERCENTILE ALIGNMENT illustrates benchmarking against defined peer cohorts. Rankings are context-sensitive. Cohort definitions are stored.

FIG. 3C COMPOSITE SCORING illustrates weighted aggregation of normalized indices. Weighting reflects governance priorities. Outputs are explainable.

FIG. 3D PEER GROUP CONFIGURATION illustrates selection and definition of benchmarking cohorts. Comparisons are fair and auditable. Definitions are retained.

FIG. 3E SCORED OUTPUT DATASET illustrates final influence scores with provenance links. Data is governance-ready. Traceability is preserved.

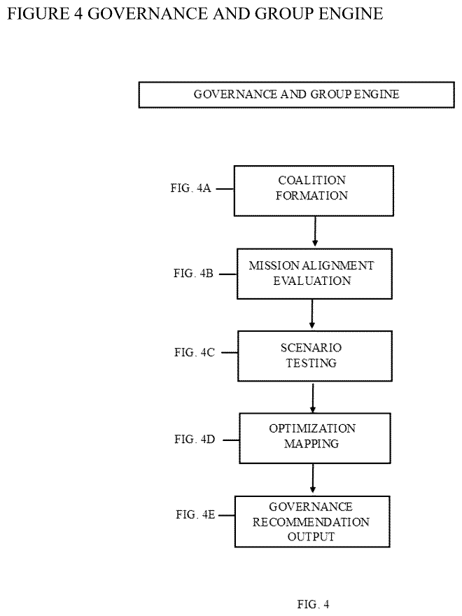

### FIG. 4 Governance and Group Engine

FIG. 4 illustrates transformation of influence scores into governance decisions. Group dynamics are evaluated. Trade-offs are visualized.

FIG. 4A COALITION FORMATION illustrates generation of candidate groupings based on complementary attributes. Multiple options are produced. Reasoning is traceable.

FIG. 4B MISSION ALIGNMENT EVALUATION illustrates mapping of individuals or groups to objectives and constraints. Fit scores are generated. Decision logic is retained.

FIG. 4C SCENARIO TESTING illustrates stress testing under hypothetical conditions. Governance resilience is evaluated. Risks are surfaced.

FIG. 4D OPTIMIZATION MAPPING illustrates visualization of trade-offs among influence, alignment, and resilience. Decision boundaries are shown. Selection is supported.

FIG. 4E GOVERNANCE RECOMMENDATION OUTPUT illustrates structured outputs for review, export, and audit. Results are configurable. Provenance is preserved.

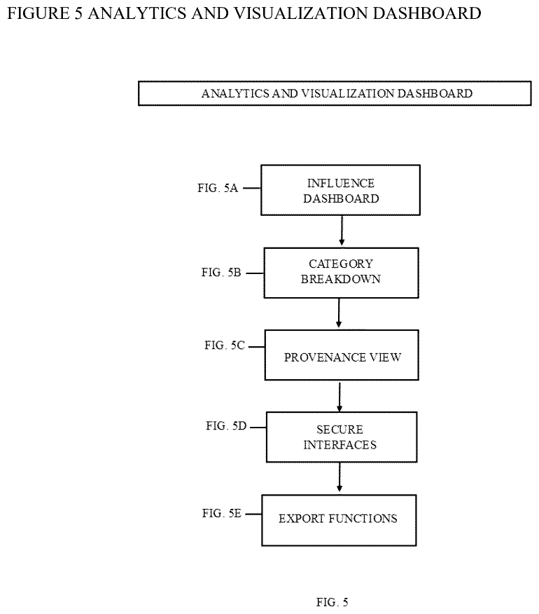

### FIG. 5 Analytics and Visualization Dashboard

FIG. 5 illustrates an interactive environment for reviewing influence scores and governance outputs. Transparency is emphasized. Access is controlled.

FIG. 5A INFLUENCE DASHBOARD illustrates real-time visualization of scores and trends. Alerts may be generated. User interaction is supported.

FIG. 5B CATEGORY BREAKDOWN illustrates contribution of scoring dimensions. Drivers of composite scores are visible. Comparative analysis is enabled.

FIG. 5C PROVENANCE VIEW illustrates traceable integrity proofs and validation evidence. Independent verification is supported. Audit review is facilitated.

FIG. 5D SECURE INTERFACES illustrates controlled programmatic access for integration. Authentication and authorization are enforced. Policies are applied.

FIG. 5E EXPORT FUNCTIONS illustrates generation of compliance-ready reports. Formats are configurable. Export actions are logged.

### ENABLEMENT EXAMPLES

### Example 1—Board Selection

Validated records from multiple independent sources are ingested and normalized. Composite influence scores are generated and evaluated. Coalition options are assessed for mission alignment and regulatory resilience.

### Example 2—Multi-Organization Consortium

A white-label deployment is configured for multiple partner organizations. Data sovereignty and privacy rules are enforced. Governance outputs are shared with full audit traceability.

1. A computer-implemented system comprising validation, normalization, scoring, governance optimization, and analytics modules configured to produce auditable influence and governance outputs from authenticated multi-source records.

2. A computer-implemented method comprising validating influence records, generating normalized and percentile-aligned scores, and producing governance recommendations including coalition formation and mission alignment.

3. A non-transitory computer-readable medium storing instructions that cause performance of influence validation, scoring, governance optimization, and auditable output generation.

4. The system of claim 1, wherein validation requires corroboration from multiple independent sources.

5. The system of claim 1, wherein cryptographic provenance ensures tamper resistance.

6. The method of claim 2, wherein percentile alignment is peer-group specific.

7. The system of claim 1, wherein governance outputs include scenario testing.

8. The system of claim 1, wherein deployment is white-label configurable.

9. The system of claim 1, wherein analytics outputs are compliance-ready.

10. The method of claim 2, wherein composite scores are weight-configurable.
